(19) United States
(12) Patent Application Publication
(10) Pub. No.: US 2026/0311158 A1
(43) Pub. Date: Oct. 8, 2026

(54) System, Method, and Computer Program Product for Transferring Assets with a Virtual Account

(71) Applicant: Visa International Service Association, San Francisco, CA (US)

(72) Inventors: Shibabrata Sanjib Kundu, Kolkata (IN); Sandipa Das, Kolkata (IN); Rakesh Kumar Barik, Baripada (IN); Varadharajan Seshadri, Chennai (IN)

(21) Appl. No.: 19/483,284

(22) PCT Filed: May 12, 2023
(86) PCT No.: PCT/US2023/022008

§ 371 Date: Nov. 11, 2025

(51) Int. Cl. G06Q 20/22

(52) U.S. Cl. CPC G06Q 20/223

(57) ABSTRACT

Provided are systems, methods, and computer program products for transferring assets with a virtual account. The system may receive a request from a first device operated by a first user to transfer a payment amount from a first user account corresponding to the first user and a first payment processing network to a second user having a peer-to-peer (P2P) payment account, and determine a payment system corresponding to the P2P payment account. A virtual account creation request may be generated based on the P2P payment account and communicated to the payment system associated with the P2P payment account. The system may receive a virtual account identifier corresponding to the second user in response to the virtual account creation request and transfer the payment amount from the first user account associated with the first user to an account corresponding to the virtual account identifier.

### CROSS REFERENCE TO RELATED APPLICATION

This application is the United States national phase of International Application No. PCT/US23/22008, filed May 12, 2023, the disclosure of which is hereby incorporated by reference in its entirety.

### BACKGROUND

### 1. Technical Field

The present disclosure relates generally to transferring assets and, in some non-limiting embodiments or aspects, to systems, methods, and computer program products for transferring assets with a virtual account.

### 2. Technical Considerations

Electronic wallets use applications installed on electronic devices to allow users to seamlessly transfer assets (e.g., funds) from one electronic wallet to another. Some existing applications are not compatible with other applications. For example, where a first type of electronic wallet is not compatible with a second type of electronic wallet, a user of the first type of electronic wallet may not be able to transfer funds to a user of the second type of electronic wallet. Further, some existing applications do not protect users from risks associated with such transfers (e.g., fraud). In some cases, users affected by fraud may have to coordinate with their respective financial institutions (e.g., banks) to settle disputes that may arise.

### SUMMARY

Accordingly, provided are improved systems, devices, products, and/or methods for transferring assets with a virtual account.

In some non-limiting embodiments or aspects, provided is a method for transferring assets with a virtual account. In some non-limiting embodiments or aspects, the method may include receiving, with at least one processor, a request from a first device operated by a first user to transfer a payment amount from a first user account corresponding to the first user and a first payment processing network to a second user having a peer-to-peer payment account. In some non-limiting embodiments or aspects, the method may further include determining, with at least one processor, a payment system corresponding to the peer-to-peer payment account. In some non-limiting embodiments or aspects, the method may further include generating, with at least one processor, a virtual account creation request based on the peer-to-peer payment account. In some non-limiting embodiments or aspects, the method may further include communicating, with at least one processor, the virtual account creation request to the payment system associated with the peer-to-peer payment account. In some non-limiting embodiments or aspects, the method may further include receiving, with at least one processor, a virtual account identifier corresponding to the second user in response to the virtual account creation request. In some non-limiting embodiments or aspects, the method may further include transferring, with at least one processor, the payment amount from the first user account associated with the first user to an account corresponding to the virtual account identifier.

In some non-limiting embodiments or aspects, the method may further include receiving an account identifier associated with the second user and the peer-to-peer payment account; querying the payment system to request data associated with the payment system corresponding to the peer-to-peer payment account based on the account identifier; and receiving the data associated with the payment system corresponding to the peer-to-peer payment account. In some non-limiting embodiments or aspects, when determining the payment system, the method may include determining the payment system corresponding to the peer-to-peer payment account based on the data associated with the payment system corresponding to the peer-to-peer payment account. In some non-limiting embodiments or aspects, the method may further include receiving a response message from the payment system corresponding to the peer-to-peer payment account, the response message comprising an indication that the payment system determined to generate the virtual account identifier to receive the payment amount from the first user account. In some non-limiting embodiments or aspects, the method may further include receiving an input from the first user via a graphical user interface of an application associated with the first payment processing network; and generating the request based on the input received from the user. In some non-limiting embodiments or aspects, the method may further include generating the virtual account identifier corresponding to the second user based on determining to generate the virtual account identifier to receive the payment amount from the first user account; generating a response to the virtual account creation request, the response comprising the virtual account identifier corresponding to the second user; and communicating the response to the first payment processing network. In some non-limiting embodiments or aspects, the virtual account identifier corresponds to at least one of a debit card and a prepaid payment card. In some non-limiting embodiments or aspects, the payment system comprises an issuer system corresponding to the peer-to-peer payment account.

In some non-limiting embodiments or aspects, provided is a system for transferring assets with a virtual account. In some non-limiting embodiments or aspects, the system may include at least one processor programmed or configured to receive a request from a first device operated by a first user to transfer a payment amount from a first user account corresponding to the first user and a first payment processing network to a second user having a peer-to-peer payment account. In some non-limiting embodiments or aspects, the at least one processor may be further programmed or configured to determine a payment system corresponding to the peer-to-peer payment account. In some non-limiting embodiments or aspects, the at least one processor may be further programmed or configured to generate a virtual account creation request based on the peer-to-peer payment account; communicate the virtual account creation request to the payment system associated with the peer-to-peer payment account. In some non-limiting embodiments or aspects, the at least one processor may be further programmed or configured to receive a virtual account identifier corresponding to the second user in response to the virtual account creation request. In some non-limiting embodiments or aspects, the at least one processor may be further programmed or configured to transfer the payment amount from the first user account associated with the first user to an account corresponding to the virtual account identifier.

In some non-limiting embodiments or aspects, the at least one processor may be further programmed or configured to receive an account identifier associated with the second user and the peer-to-peer payment account; query the payment system to request data associated with the payment system corresponding to the peer-to-peer payment account based on the account identifier; and receive the data associated with the payment system corresponding to the peer-to-peer payment account. In some non-limiting embodiments or aspects, when determining the payment system, the at least one processor may be programmed or configured to determine the payment system corresponding to the peer-to-peer payment account based on the data associated with the payment system corresponding to the peer-to-peer payment account. In some non-limiting embodiments or aspects, the at least one processor may be further programmed or configured to receive a response message from the payment system corresponding to the peer-to-peer payment account, the response message comprising an indication that the payment system determined to generate the virtual account identifier to receive the payment amount from the first user account. In some non-limiting embodiments or aspects, the at least one processor may be further programmed or configured to receive an input from the first user via a graphical user interface of an application associated with the first payment processing network; and generate the request based on the input received from the user. In some non-limiting embodiments or aspects, the at least one processor may be further programmed or configured to generate the virtual account identifier corresponding to the second user based on determining to generate the virtual account identifier to receive the payment amount from the first user account; generate a response to the virtual account creation request, the response comprising the virtual account identifier corresponding to the second user; and communicate the response to the first payment processing network. In some non-limiting embodiments or aspects, the virtual account identifier corresponds to at least one of a debit card and a prepaid payment card. In some non-limiting embodiments or aspects the payment system comprises an issuer system corresponding to the peer-to-peer payment account.

In some non-limiting embodiments or aspects, provided is a computer program product comprising at least one non-transitory computer readable medium comprising one or more instructions that, when executed by at least one processor, cause the at least one processor to receive a request from a first device operated by a first user to transfer a payment amount from a first user account corresponding to the first user and a first payment processing network to a second user having a peer-to-peer payment account. In some non-limiting embodiments or aspects, the one or more instructions may further cause the at least one processor to determine a payment system corresponding to the peer-to-peer payment account. In some non-limiting embodiments or aspects, the one or more instructions may further cause the at least one processor to generate a virtual account creation request based on the peer-to-peer payment account; communicate the virtual account creation request to the payment system associated with the peer-to-peer payment account. In some non-limiting embodiments or aspects, the one or more instructions may further cause the at least one processor to receive a virtual account identifier corresponding to the second user in response to the virtual account creation request. In some non-limiting embodiments or aspects, the one or more instructions may further cause the at least one processor to transfer the payment amount from the first user account associated with the first user to an account corresponding to the virtual account identifier.

In some non-limiting embodiments or aspects, the one or more instructions may further cause the at least one processor to receive an account identifier associated with the second user and the peer-to-peer payment account; query the payment system to request data associated with the payment system corresponding to the peer-to-peer payment account based on the account identifier; and receive the data associated with the payment system corresponding to the peer-to-peer payment account. In some non-limiting embodiments or aspects, when determining the second system, the one or more instructions may cause the at least one processor to determine the second system corresponding to the peer-to-peer payment account based on the data associate with the payment system corresponding to the peer-to-peer payment account. In some non-limiting embodiments or aspects, the one or more instructions may further cause the at least one processor to receive a response message from the payment system corresponding to the peer-to-peer payment account, the response message comprising an indication that the payment system determined to generate the virtual account identifier to receive the payment amount from the first user account. In some non-limiting embodiments or aspects, the one or more instructions may further cause the at least one processor to receive an input from the first user via a graphical user interface of an application associated with the first payment processing network; and generate the request based on the input received from the user. In some non-limiting embodiments or aspects, the one or more instructions further cause the at least one processor to: generate the virtual account identifier corresponding to the second user based on determining to generate the virtual account identifier to receive the payment amount from the first user account; generate a response to the virtual account creation request, the response comprising the virtual account identifier corresponding to the second user; and communicate the response to the first payment processing network. In some non-limiting embodiments or aspects, the virtual account identifier corresponds to at least one of a debit card and a prepaid payment card. In some non-limiting embodiments or aspects, the payment system comprises an issuer system corresponding to the peer-to-peer payment account.

Further non-limiting embodiments or aspects will be set forth in the following numbered clauses:

Clause 1: A method comprising: receiving, with at least one processor, a request from a first device operated by a first user to transfer a payment amount from a first user account corresponding to the first user and a first payment processing network to a second user having a peer-to-peer payment account; determining, with at least one processor, a payment system corresponding to the peer-to-peer payment account; generating, with at least one processor, a virtual account creation request based on the peer-to-peer payment account; communicating, with at least one processor, the virtual account creation request to the payment system associated with the peer-to-peer payment account; receiving, with at least one processor, a virtual account identifier corresponding to the second user in response to the virtual account creation request; and transferring, with at least one processor, the payment amount from the first user account associated with the first user to an account corresponding to the virtual account identifier.

Clause 2: The method of clause 1, further comprising: receiving an account identifier associated with the second user and the peer-to-peer payment account; querying the payment system to request data associated with the payment system corresponding to the peer-to-peer payment account based on the account identifier; and receiving the data associated with the payment system corresponding to the peer-to-peer payment account.

Clause 3: The method of clause 1 or clause 2, wherein determining the payment system comprises: determining the payment system corresponding to the peer-to-peer payment account based on the data associated with the payment system corresponding to the peer-to-peer payment account.

Clause 4: The method of any of clauses 1-3, further comprising: receiving a response message from the payment system corresponding to the peer-to-peer payment account, the response message comprising an indication that the payment system determined to generate the virtual account identifier to receive the payment amount from the first user account.

Clause 5: The method of any of clauses 1-4, further comprising: receiving an input from the first user via a graphical user interface of an application associated with the first payment processing network; and generating a request based on the input received from the user.

Clause 6: The method of any of clauses 1-5, further comprising: generating the virtual account identifier corresponding to the second user based on determining to generate the virtual account identifier to receive the payment amount from the first user account; generating a response to the virtual account creation request, the response comprising the virtual account identifier corresponding to the second user; and communicating the response to the first payment processing network.

Clause 7: The method of any of clauses 1-6, wherein the virtual account identifier corresponds to at least one of a debit card and a prepaid payment card.

Clause 8: The method of any of clauses 1-7, wherein the payment system comprises an issuer system corresponding to the peer-to-peer payment account.

Clause 9: A system comprising at least one processor, the at least one processor programmed or configured to: receive a request from a first device operated by a first user to transfer a payment amount from a first user account corresponding to the first user and a first payment processing network to a second user having a peer-to-peer payment account; determine a payment system corresponding to the peer-to-peer payment account; generate a virtual account creation request based on the peer-to-peer payment account; communicate the virtual account creation request to the payment system associated with the peer-to-peer payment account; receive a virtual account identifier corresponding to the second user in response to the virtual account creation request; and transfer the payment amount from the first user account associated with the first user to an account corresponding to the virtual account identifier.

Clause 10: The system of clause 9, wherein the at least one processor is further programmed or configured to: receive an account identifier associated with the second user and the peer-to-peer payment account; query the payment system to request data associated with the payment system corresponding to the peer-to-peer payment account based on the account identifier; and receive the data associated with the payment system corresponding to the peer-to-peer payment account.

Clause 11: The system of clause 9 or clause 10, wherein, when determining the payment system, at least one processor is programmed or configured to: determine the payment system corresponding to the peer-to-peer payment account based on the data associated with the payment system corresponding to the peer-to-peer payment account.

Clause 12: The system of any of clauses 9-11, wherein the at least one processor is further programmed or configured to: receive a response message from the payment system corresponding to the peer-to-peer payment account, the response message comprising an indication that the payment system determined to generate the virtual account identifier to receive the payment amount from the first user account.

Clause 13: The system of any of clauses 9-12, wherein the at least one processor is further programmed or configured to: receive an input from the first user via a graphical user interface of an application associated with the first payment processing network; and generate a request based on the input received from the user.

Clause 14: The system of any of clauses 9-13, wherein the at least one processor is further programmed or configured to: generate the virtual account identifier corresponding to the second user based on determining to generate the virtual account identifier to receive the payment amount from the first user account; generate a response to the virtual account creation request, the response comprising the virtual account identifier corresponding to the second user; and communicate the response to the first payment processing network.

Clause 15: The system of any of clauses 9-14, wherein the virtual account identifier corresponds to at least one of a debit card and a prepaid payment card.

Clause 16: The system of any of clauses 9-15, wherein the payment system comprises an issuer system corresponding to the peer-to-peer payment account.

Clause 17: A computer program product comprising at least one non-transitory computer readable medium comprising one or more instructions that, when executed by at least one processor, cause the at least one processor to: receive a request from a first device operated by a first user to transfer a payment amount from a first user account corresponding to the first user and a first payment processing network to a second user having a peer-to-peer payment account; determine a payment system corresponding to the peer-to-peer payment account; generate a virtual account creation request based on the peer-to-peer payment account; communicate the virtual account creation request to the payment system associated with the peer-to-peer payment account; receive a virtual account identifier corresponding to the second user in response to the virtual account creation request; and transfer the payment amount from the first user account associated with the first user to an account corresponding to the virtual account identifier.

Clause 18: The computer program product of clause 17, wherein the one or more instructions further cause the at least one processor to: receive an account identifier associated with the second user and the peer-to-peer payment account; query the payment system to request data associated with the payment system corresponding to the peer-to-peer payment account based on the account identifier; and receive the data associated with the payment system corresponding to the peer-to-peer payment account.

Clause 19: The computer program product of clause 17 or clause 18, wherein, when determining the second system, the one or more instructions cause the at least one processor to: determine the second system corresponding to the peer-to-peer payment account based on the data associate with the payment system corresponding to the peer-to-peer payment account.

Clause 20: The computer program product of any of clauses 17-19, wherein the one or more instructions further cause the at least one processor to: receive a response message from the payment system corresponding to the peer-to-peer payment account, the response message comprising an indication that the payment system determined to generate the virtual account identifier to receive the payment amount from the first user account.

Clause 21: The computer program product of any of clauses 17-20, wherein the one or more instructions further cause the at least one processor to: receive an input from the first user via a graphical user interface of an application associated with the first payment processing network; and generate a request based on the input received from the user.

Clause 22: The computer program product of any of clauses 17-21, wherein the one or more instructions further cause the at least one processor to: generate the virtual account identifier corresponding to the second user based on determining to generate the virtual account identifier to receive the payment amount from the first user account; generate a response to the virtual account creation request, the response comprising the virtual account identifier corresponding to the second user; and communicate the response to the first payment processing network.

Clause 23: The computer program product of any of clauses 17-22, wherein the virtual account identifier corresponds to at least one of a debit card and a prepaid payment card.

Clause 24: The computer program product of any of clauses 17-23, wherein the payment system comprises an issuer system corresponding to the peer-to-peer payment account.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are illustrated in the accompanying schematic figures, in which:

FIG. 1 is a diagram of a non-limiting embodiment or aspect of an environment in which systems, devices, products, and/or methods, described herein, may be implemented according to the principles of the present disclosure;

FIG. 2 is a schematic diagram and flow chart of a non-limiting embodiments or aspects of a system for transferring assets with a virtual account according to some non-limiting embodiments or aspects; and

FIG. 3 is a diagram of a non-limiting embodiment or aspect of components of one or more devices of FIG. 1.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a Bank Identification Number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments or aspects, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments or aspects of the present disclosure are directed to systems, methods, and computer program products for transferring assets with a virtual account. The non-limiting embodiments described in the present disclosure enable users to transfer assets to and/or from a virtual account. For example a first user may transfer funds to a second user using a virtual account created ad hoc in correspondence with a peer-to-peer (“P2P”) payment account, such as Unified Payments Interface (“UPI”) or other P2P payment platforms (e.g., PayPal, Venmo®, and/or the like). This can be used in an example where the recipient of the payment does not have an account associated with a standard payment network, but only a P2P account, and the payer/sender is making the payment using an account on a standard payment network. Non-limiting embodiments disrupt the typical flow of events that occur in response to a payment transfer request by effectively bridging the gap between two different and/or separate payment systems and allowing users of the payment systems to engage in P2P transactions without the need to have a common payment service provider. This provides a seamless payment process to the payer, who does not have to perform additional steps and/or use different applications and/or services to make a payment to a recipient that does not have a compatible payment account. In non-limiting embodiments, the reduction of steps needed to make such a payment also reduces the number of parties and, thus, reduces the amount of computing resources and communications needed to make such a payment.

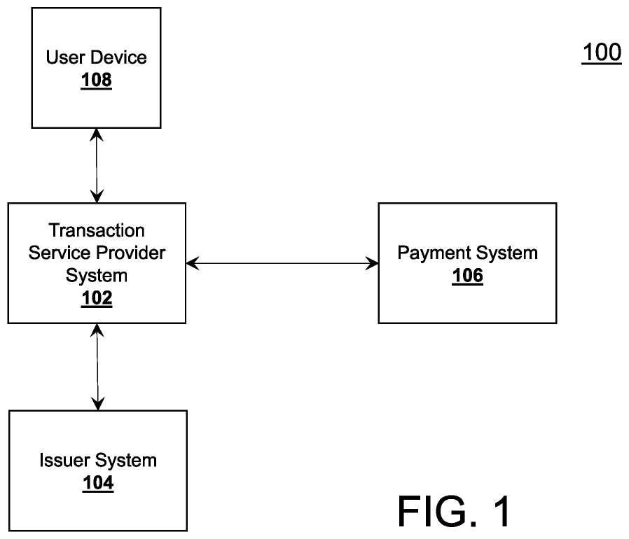

Referring now to FIG. 1, shown is a diagram of an example environment 100 in which devices, systems, and/or methods, described herein, may be implemented. As shown in FIG. 1, environment 100 includes transaction service provider system 102, issuer system 104, payment system 106, and user device 108. Transaction service provider system 102, issuer system 104, payment system 106, and/or user device 108 may interconnect (e.g., establish a connection to communicate) via wired connections, wireless connections, or a combination of wired and wireless connections.

Transaction service provider system 102 may include one or more devices configured to communicate with issuer system 104, payment system 106, and/or user device 108. For example, transaction service provider system 102 may include a server, a group of servers, and/or other like devices. In some non-limiting embodiments or aspects, transaction service provider system 102 may include a processor and/or a memory, as described herein. In some non-limiting embodiments or aspects, transaction service provider system 102 may include one or more software instructions (e.g., one or more software applications) executing on a server (e.g., a single server), a group of servers, a computing device (e.g., a single computing device), a group of computing devices, and/or other like devices. In some non-limiting embodiments or aspects, transaction service provider system 102 may be associated with a transaction service provider system, as described herein. In some non-limiting embodiments or aspects, transaction service provider system 102 may be in communication with a data storage device, which may be local or remote to transaction service provider system 102. In some non-limiting embodiments or aspects, transaction service provider system 102 may be capable of receiving information from, storing information in, transmitting information to, and/or searching information stored in the data storage device.

Issuer system 104 may include one or more devices configured to communicate with transaction service provider system 102. For example, issuer system 104 may include a server, a group of servers, and/or other like devices. In some non-limiting embodiments or aspects, issuer system 104 may include a processor and/or a memory, as described herein. In some non-limiting embodiments or aspects, issuer system 104 may include one or more software instructions (e.g., one or more software applications) executing on a server (e.g., a single server), a group of servers, a computing device (e.g., a single computing device), a group of computing devices, and/or other like devices. In some non-limiting embodiments or aspects, issuer system 104 may be associated with a financial institution (e.g., a bank), as described herein. In some non-limiting embodiments or aspects, issuer system 104 may be in communication with a data storage device, which may be local or remote to issuer system 104. In some non-limiting embodiments or aspects, issuer system 104 may be capable of receiving information from, storing information in, transmitting information to, and/or searching information stored in the data storage device.

Payment system 106 may include one or more devices configured to communicate with transaction service provider system 102. For example, payment system 106 may include a server, a group of servers, and/or other like devices. In some non-limiting embodiments or aspects, payment system 106 may include a processor and/or a memory, as described herein. In some non-limiting embodiments or aspects, payment system 106 may include one or more software instructions (e.g., one or more software applications) executing on a server (e.g., a single server), a group of servers, a computing device (e.g., a single computing device), a group of computing devices, and/or other like devices. In some non-limiting embodiments or aspects, payment system 106 may be associated with a transaction service provider, a P2P network, and/or a financial institution (e.g., a bank), as described herein. In some non-limiting embodiments or aspects, payment system 106 may include a P2P network (e.g., UPI, Venmo®, etc.) and/or a second issuer system. For example, payment system 106 may refer to a P2P payment network and one or more financial institutions (e.g., associated with issuer systems) that users of the P2P payment network have linked to their P2P accounts (e.g., a linked account with an issuer for depositing and/or transferring). Thus, in such non-limiting embodiments or examples, the payment system 106 may be separate systems and entities and not a single system as shown for illustration purposes in FIG. 1. In some non-limiting embodiments or aspects, payment system 106 may be in communication with a data storage device, which may be local or remote to payment system 106. In some non-limiting embodiments or aspects, payment system 106 may be capable of receiving information from, storing information in, transmitting information to, and/or searching information stored in the data storage device.

User device 108 may include a computing device configured to communicate with transaction service provider system 102. For example, user device 108 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 108 may be associated with a user (e.g., an individual operating user device 108).

In some non-limiting embodiments or aspects, transaction service provider system 102 may receive a request from user device 108. For example, transaction service provider system 102 may receive a request from user device 108 operated by a first user to transfer a payment amount from a first user account corresponding to the first user and a first payment processing network to a second user having a P2P payment account.

In some non-limiting embodiments or aspects, user device 108 may receive an input from the first user via a graphical user interface (GUI) of an application being executed on user device 108. The GUI of the application may display data associated with the input from the user via a screen of user device 108. The input may also be spoken, audio input, gesture input, and/or other like forms of input with or without a GUI. In some non-limiting embodiments or aspects, user device 108 and/or the application associated with the first payment processing network running on user device 108 may generate the request based on the input received from the user. In some non-limiting embodiments or aspects, user device 108 and/or the application associated with the first payment processing network running on user device 108 may communicate the request to transaction service provider system 102.

In some non-limiting embodiments or aspects, transaction service provider system 102 may receive an account identifier (e.g., a unique handle) associated with the second user and the P2P payment account. For example, transaction service provider system 102 may receive an account identifier comprising a unique identifier of the second user and/or a unique identifier of a financial institution (e.g., xxxx@ffff, where xxxx is the unique identifier of the second user and where ffff is the unique identifier of the financial institution) associated with the second user and the P2P payment account from payment system 106 and/or user device 108.

In some non-limiting embodiments or aspects, transaction service provider system 102 may determine a payment system corresponding to the P2P payment account. In some non-limiting embodiments or aspects, when determining the payment system corresponding to the P2P payment account, transaction service provider system 102 may query the payment system 106 (e.g., the P2P payment network and/or the second issuer) to request data associated with the payment system corresponding to the P2P payment account. For example, transaction service provider system 102 may query the P2P payment network and/or the second issuer to request data (e.g., an identifier of an issuer such as a code and/or a BIN) associated with the P2P network and/or the second issuer corresponding to the P2P payment account based on the account identifier. In some non-limiting embodiments or aspects, transaction service provider system 102 may receive the data (e.g., the code and/or the BIN) associated with the payment system 106 corresponding to the P2P payment account from the P2P payment network and/or the second issuer. In some non-limiting embodiments or aspects, transaction service provider system 102 may determine the payment system corresponding to the P2P payment account based on receiving the account identifier and/or data associated with the payment system corresponding to the P2P payment account.

In some non-limiting embodiments or aspects, transaction service provider system 102 may generate a virtual account creation request based on the P2P payment account (e.g., data associate with the P2P payment account). For example, transaction service provider system 102 may generate the virtual account creation request automatically in response to receiving the data associated with the P2P payment account and by including the data (e.g., an identifier of an issuer such as the code and/or the BIN) or a portion thereof in a virtual account creation request message.

In some non-limiting embodiments or aspects, transaction service provider system 102 may communicate (e.g., transmit) the virtual account creation request to the payment system associated with the P2P payment account. For example, transaction service provider system 102 may communicate the virtual account creation request to the P2P payment network and/or the second issuer.

In some non-limiting embodiments or aspects, payment system 106 may determine whether or not to generate a virtual account identifier to receive the payment amount from the first user account. For example, the P2P payment network and/or the second issuer may determine to generate the virtual account identifier to receive the payment amount from the first user account based on receiving the virtual account creation request from transaction service provider system 102. In some non-limiting embodiments or aspects, based on determining to generate a virtual account identifier to receive the payment amount from the user account (e.g., in response to determining to generate the virtual account identifier), the second issuer may automatically generate a response message comprising an indication that the payment system determined to generate the virtual account identifier to receive the payment amount from the first user account. In some non-limiting embodiments or aspects, the P2P payment network and/or the second issuer may communicate the response message to transaction service provider system 102.

In some non-limiting embodiments or aspects, transaction service provider system 102 may receive the response message. For example, transaction service provider system 102 may receive the response message from the P2P payment network and/or the second issuer, the response message comprising an indication that the P2P payment network and/or the second issuer has determined to generate the virtual account identifier.

In some non-limiting embodiments or aspects, payment system 106 may generate the virtual account identifier corresponding to the second user. For example, the second issuer may generate the virtual account identifier corresponding to the user (e.g., automatically) based on receiving the virtual account creation request from transaction service provider system 102. In some non-limiting embodiments or aspects, the response message may include the virtual account identifier corresponding to the second user. Additionally or alternatively, the P2P payment network and/or the second issuer may generate a second response message comprising the virtual account identifier corresponding to the second user and communicate the second response message to transaction service provider system 102. In some non-limiting embodiments or aspects, the virtual account identifier corresponds to at least one of a debit card and/or a prepaid payment card. In some non-limiting embodiments or aspects, transaction service provider system 102 may receive a virtual account identifier from the P2P payment network and/or second issuer in response to communicating the virtual account creation request.

In some non-limiting embodiments or aspects, transaction service provider system 102 may transfer the payment amount from the first user account associated with the first user to an account corresponding to the virtual account identifier.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

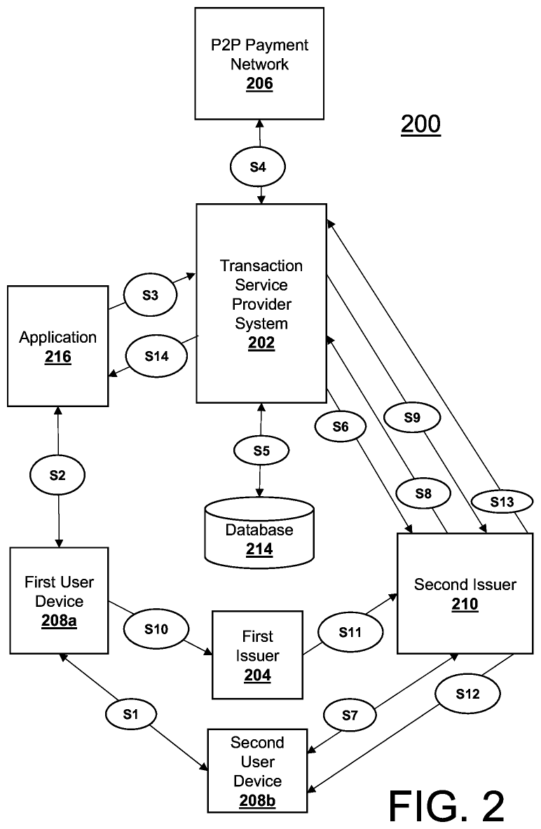

Referring now to FIG. 2, shown is a schematic diagram and flow chart of a system 200 for transferring assets with a virtual account according to some non-limiting embodiments or aspects. In some non-limiting embodiments or aspects, transaction service provider system 202 may be the same as, similar to, and/or part of transaction service provider system 102. In some non-limiting embodiments or aspects, first issuer 204 and/or second issuer 210 may be the same as, similar to, and/or part of issuer system 104. In some non-limiting embodiments or aspects, P2P network 206 may be the same as, similar to, and/or part of payment system 106. In some non-limiting embodiments or aspects, first user device 208a and/or second user device 208b may be the same as, similar to, and/or part of user device 108. In some non-limiting embodiments or aspects, second issuer 210 may be the same as, similar to, and/or part of payment system 106. In some non-limiting embodiments or aspects, database 214 may include a data storage device, as described herein. In some non-limiting embodiments or aspects, application 216 may be a payment application accessible by a user device, including one or more server-side software applications hosted by transaction service provider system 102 and/or payment system 106, one or more client-side applications (e.g., mobile applications) executable by a user device, such as first user device 208a and/or second user device 208b, that communicates with a remote server, and/or the like. In some non-limiting embodiments or aspects, application 216 may be accessible by a user device through a browser, such as a web-based application.

In some non-limiting embodiments or aspects, first user device 208a and second user device 208b may be computing devices operated by a first user and a second user, respectively. In the example shown, a first user account may correspond to the first user (operating first user device 208a) and/or a first payment processing network. In some non-limiting embodiments or aspects, a P2P payment account may correspond to the second user (operating second user device 208b). In some non-limiting embodiments or aspects, first user device 208a may correspond to the first user (e.g., a sender/payer) and/or second user device 208b may correspond to the second user (e.g., a receiver/payee).

As shown in step S1, first user device 208a may communicate with the second user and/or second user device 208b. For example, second user device 208b may communicate data comprising at least an account identifier to first user device 208a upon request, in response to an initial message, or the like. The account identifier may include data associated with second user device 208b, the second user, and/or the P2P account. For example, the account identifier may include an identification code associated with the P2P payment account (e.g., a UPI identification code) and/or a handle associated with the P2P payment account (e.g., xxxxxx@ffff, where xxxxxx is a unique identification associated with the second user and ffff is a unique identification associated with second issuer 210).

In some non-limiting embodiments or aspects, first user device 208a may receive the data comprising the account identifier from the second user via second user device 208b and/or any other communication means (e.g., scanning a QR code or other indicia, Bluetooth® communication, near field communication, and/or the like).

As shown in step S2, first user device 208a may communicate with application 216. For example, upon receiving the account identifier from second user device 208b, first user device 208a may automatically communicate the account identifier to application 216.

In some non-limiting embodiments or aspects, first user device 208a may include application 216. In some non-limiting embodiments or aspects, application 216 may be a software application installed and/or running on first user device 208a and/or second user device 208b. In some non-limiting embodiments or aspects, application 216 may be executed on first user device 208a. In some non-limiting embodiments or aspects, application 216 may be accessible by a webpage via first user device 208a. In some non-limiting embodiments or aspects, application 216 may provide users with the option to perform money transfers. For example, when installed on first user device 208a, application 216 may provide the first user with the option to transfer a payment amount from the first account associated with the first user to the P2P payment account associated with the second user.

In some non-limiting embodiments or aspects, first user device 208a and/or application 216 may store data associated with the first user. For example, first user device 208a and/or application 216 may store data associated with the first user account corresponding to the first user and the first payment processing network, such as a PAN or other account identifier (e.g., a debit card number, a prepaid payment card number, a payment token, and/or the like).

As shown in step S3, application 216 may communicate with transaction service provider system 202. For example, in response to receiving the account identifier, application 216 may generate and communicate a request to transfer a payment amount from the first user account corresponding to the first user and a first payment processing network to the second user having the P2P payment account. In some non-limiting embodiments or aspects, the request to transfer the payment amount from the first user account corresponding to the first user and the first payment processing network to the second user having the P2P payment account may be a first request. In some non-limiting embodiments or aspects, the first request may include data including at least the account identifier. In some non-limiting embodiments or aspects, first user device 208a may communicate the first request to transaction service provider system 202. In some non-limiting embodiments or aspects, transaction service provider system 202 may receive the first request from first user device 208a and/or application 216.

As shown in step S4, transaction service provider system 202 may communicate with P2P payment network 206. For example, in response to receiving the first request, transaction service provider system 202 may generate and send a second request including a message configured to cause P2P payment network 206 to provide data associated with the payment system corresponding to the P2P payment account. In some non-limiting embodiments or aspects, the second request may include at least the account identifier.

As shown in step S5, transaction service provider system 202 may communicate with database 214. For example, the transaction service provider system 202 may query database 214 and/or extract data from database 214 to determine the payment system corresponding to the P2P payment account.

In some non-limiting embodiments or aspects, transaction service provider system 202 may determine the payment system corresponding to the P2P payment account. For example, in response to receiving the second request, transaction service provider system 202 may determine that the payment system corresponding to the P2P payment account is the same as and/or part of second issuer 210 based on the account identifier.

In some non-limiting embodiments or aspects, when determining the payment system corresponding to the P2P payment account, transaction service provider system 202 may query P2P payment network 206 to request data associated with the payment system corresponding to the P2P payment account based on receiving the account identifier. For example, the querying may be performed automatically in response to receiving the account identifier. In some non-limiting embodiments or aspects, in response to the querying, transaction service provider system 202 may receive the data (e.g., identifier code, a payment service provider code, and/or BIN) associated with the payment system corresponding to the P2P payment account from P2P payment network 206. In some non-limiting embodiments or aspects, the data associated with the payment system corresponding to the P2P payment account may comprise a unique identification code associated with a financial institution. In some non-limiting embodiments or aspects, transaction service provider system 202 may determine that the payment system corresponding to the P2P payment account is second issuer 210 based on receiving a unique identification code associated with second issuer 210.

In some non-limiting embodiments or aspects, transaction service provider system 202 may generate a virtual account creation request based on determining the payment system corresponding to the P2P payment account. The virtual account creation request may include, for example, a message with data associated with the payment system and/or the unique identification code associated with second issuer 210. In some non-limiting embodiments or aspects, the virtual account creation request may be a third request.

As shown in step S6, transaction service provider system 202 may communicate with second issuer 210. In some non-limiting embodiments or aspects, transaction service provider system 202 may communicate the virtual account creation request to the payment system associated with the P2P payment account (e.g., the second issuer 210). In some non-limiting embodiments or aspects, the virtual account creation request may comprise a message configured to cause the second issuer 210, or other payment system, to create and/or provide a virtual account identifier number associated with a virtual account to receive the payment amount from the first user account.

As shown in step S7, second issuer 210 may communicate with second user device 208b. For example, second issuer 210 may generate and send a message to user device 208b, the message requesting approval for the creation of the virtual account. In some non-limiting embodiments or aspects, the second user may receive the message via second user device 208b from second issuer 210 and determine whether to approve or deny the creation of the virtual account. In some non-limiting embodiments or aspects, determining to approve the creation of the virtual account may be automatic and/or based on a previous approval for the creation of a virtual account and/or a user preference (e.g., a preference set by the second user). In some non-limiting embodiments or aspects, in response to determining to approve the creation of the virtual account, second user device 208b may communicate a response message to second issuer 210 indicating that the second user approves the creation of the virtual account to receive the payment amount from the first user account. In some non-limiting embodiments or aspects, second issuer 210 may automatically determine whether to approve or deny the creation of the virtual account based on performing one or more fraud determinations, risk determinations, and/or the like, based on the transaction data available to it and/or based on a user preference.

As shown in step S8, transaction service provider system 202 may receive a response to the virtual account creation request from second issuer 210. The response may include a message comprising an indication that the second user and/or second issuer 210 has approved the creation of the virtual account. In some non-limiting embodiments or aspects, the response may include data indicating that the second issuer 210 has determined to generate the virtual account identifier to receive the payment amount from the first user account.

In some non-limiting embodiments or aspects, second issuer 210 may generate a virtual account identifier corresponding to the second user, for example, based on determining to generate the virtual account identifier to receive the payment amount from the first user account. The virtual account identifier may be automatically generated in response to determining to generate the virtual account identifier. In some non-limiting embodiments or aspects, second issuer 210 may generate a response to the virtual account creation request comprising the virtual account identifier corresponding to the second user and/or communicate the response to transaction service provider system 202. In some non-limiting embodiments or aspects, the virtual account identifier may correspond to at least one of a debit card and/or a prepaid payment card.

As shown in step S9, in response to receiving the virtual account identifier, transaction service provider system 202 may communicate, to second issuer 210, a request to transfer the payment amount from the first user account to the virtual account. The request to transfer the payment amount from the first user account to the virtual account may be a fourth request. In some non-limiting embodiments or aspects, the fourth request may include data including at least the virtual account identifier. In some non-limiting embodiments or aspects, the payment amount may be transferred from the first user account associated with the first user to the account corresponding to the virtual account identifier.

As shown in step S10, first user device 208a may communicate with first issuer 204. For example, user device 208a may send, to first issuer 204, the payment amount from the first user account corresponding to the first user and the first payment processing network. In some non-limiting embodiments or aspects, the payment amount may be debited from the first user account corresponding to the first user and the first payment processing network and/or credited to an account associated with first issuer 204. First issuer 204 may be a financial institution (e.g., bank) associated with the first user.

As shown in step S11, first issuer 204 may communicate with second issuer 210. For example, first issuer 204 may send the payment amount to second issuer 210. In some non-limiting embodiments or aspects, the payment amount may be debited from an account associated with first issuer 204 and/or credited to an account associated with second issuer 210 (e.g., the account corresponding to the virtual account identifier). For example, the payment amount may be credited to the virtual account.

As shown in step S12, second user device 208b may receive a message and/or notification from second issuer 210. For example, in response to the payment amount being credited to the virtual account, second user device 208b may receive a message indicating that the payment amount has been credited to the virtual account. In some non-limiting embodiments or aspects, the message indicating the payment amount has been credited to the virtual account may include data including the virtual account identifier and/or the payment amount.

As shown in step S13, second issuer 210 may send an approval request to transaction service provider system 202.

As shown in step S14, transaction service provider system 202 may provide an approval response to application 216, indicating that the payment amount from the first user account associated with the first user to the account corresponding to the virtual account identifier have been approved and/or the payment amount has been transferred successfully.

The number and arrangement of devices, networks, and/or steps shown in FIG. 2 are provided as an example. There may be additional devices, networks, and/or steps fewer devices, networks, and/or steps, different devices, networks, and/or steps, or differently arranged devices, networks, and/or steps than those shown in FIG. 2. Furthermore, two or more devices shown in FIG. 2 may be implemented within a single device, or a single device shown in FIG. 2 may be implemented as multiple, distributed devices. Additionally or alternatively, a set of devices (e.g., one or more devices) of system 200 may perform one or more functions described as being performed by another set of devices of system 200.

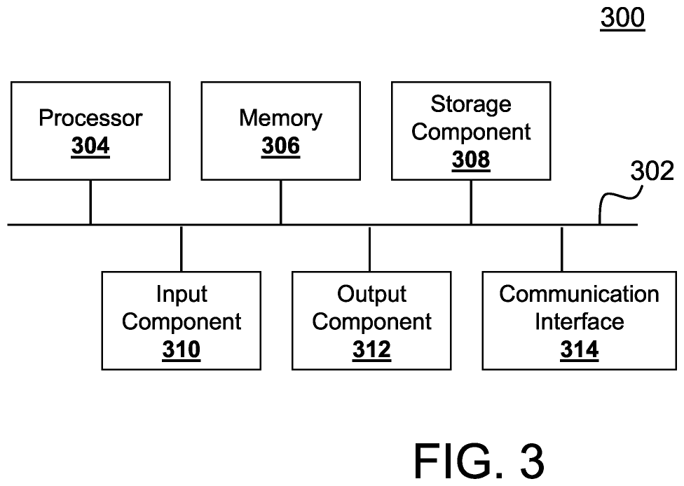

Referring now to FIG. 3, shown is a diagram of example components of a device 300. Device 300 may correspond to transaction service provider system 102 (e.g., one or more devices of transaction service provider system 102), issuer system 104 (e.g., one or more devices of issuer system 104), payment system 106 (e.g., one or more devices of payment system 106), and/or user device 108. In some non-limiting embodiments or aspects, transaction service provider system 102, issuer system 104, payment system 106, and/or user device 108 may include at least one device 300 and/or at least one component of device 300. As shown in FIG. 3, device 300 may include bus 302, processor 304, memory 306, storage component 308, input component 310, output component 312, and communication interface 314.

Bus 302 may include a component that permits communication among the components of device 300. In some non-limiting embodiments or aspects, processor 304 may be implemented in hardware, firmware, or a combination of hardware and software. For example, processor 304 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 may include random access memory (RAM), read-only memory (ROM), and/or another type of dynamic or static storage memory (e.g., flash memory, magnetic memory, optical memory, etc.) that stores information and/or instructions for use by processor 304.

Storage component 308 may store information and/or software related to the operation and use of device 300. For example, storage component 308 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 310 may include a component that permits device 300 to receive information, such as via user input (e.g., a touch screen display, a keyboard, a keypad, a mouse, a button, a switch, a microphone, etc.). Additionally or alternatively, input component 310 may include a sensor for sensing information (e.g., a global positioning system (GPS) component, an accelerometer, a gyroscope, an actuator, etc.). Output component 312 may include a component that provides output information from device 300 (e.g., a display, a speaker, one or more light-emitting diodes (LEDs), etc.).

Communication interface 314 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 314 may permit device 300 to receive information from another device and/or provide information to another device. For example, communication interface 314 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 300 may perform one or more processes described herein. Device 300 may perform these processes based on processor 304 executing software instructions stored by a computer-readable medium, such as memory 306 and/or storage component 308. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 306 and/or storage component 308 from another computer-readable medium or from another device via communication interface 314. When executed, software instructions stored in memory 306 and/or storage component 308 may cause processor 304 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 3 are provided as an example. In some non-limiting embodiments or aspects, device 300 may include additional components, fewer components, different components, or differently arranged components than those shown in FIG. 3. Additionally or alternatively, a set of components (e.g., one or more components) of device 300 may perform one or more functions described as being performed by another set of components of device 300.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A method comprising:
receiving, with at least one processor, a request from a first device operated by a first user to transfer a payment amount from a first user account corresponding to the first user and a first payment processing network to a second user having a peer-to-peer (P2P) payment account;
determining, with at least one processor, a payment system corresponding to the P2P payment account;
generating, with at least one processor, a virtual account creation request based on the P2P payment account;
communicating, with at least one processor, the virtual account creation request to the payment system associated with the P2P payment account;
receiving, with at least one processor, a virtual account identifier corresponding to the second user in response to the virtual account creation request; and
transferring, with at least one processor, the payment amount from the first user account associated with the first user to an account corresponding to the virtual account identifier.

2. The method of claim 1, further comprising:
receiving an account identifier associated with the second user and the P2P payment account;
querying the payment system to request data associated with the payment system corresponding to the P2P payment account based on the account identifier; and
receiving the data associated with the payment system corresponding to the P2P payment account.

3. The method of claim 2, wherein determining the payment system comprises:
determining the payment system corresponding to the P2P payment account based on the data associated with the payment system corresponding to the P2P payment account.

4. The method of claim 1, further comprising:
receiving a response message from the payment system corresponding to the P2P payment account, the response message comprising an indication that the payment system determined to generate the virtual account identifier to receive the payment amount from the first user account.

5. The method of claim 1, further comprising:
receiving an input from the first user via a graphical user interface of an application associated with the first payment processing network; and
generating a request based on the input received from the first user.

6. The method of claim 1, further comprising:
generating the virtual account identifier corresponding to the second user based on determining to generate the virtual account identifier to receive the payment amount from the first user account;
generating a response to the virtual account creation request, the response comprising the virtual account identifier corresponding to the second user; and
communicating the response to the first payment processing network.

7. The method of claim 1, wherein the virtual account identifier corresponds to at least one of a debit card and a prepaid payment card.

8. The method of claim 1, wherein the payment system comprises an issuer system corresponding to the P2P payment account.

9. A system comprising at least one processor, the at least one processor programmed or configured to:
receive a request from a first device operated by a first user to transfer a payment amount from a first user account corresponding to the first user and a first payment processing network to a second user having a peer-to-peer (P2P) payment account;
determine a payment system corresponding to the P2P payment account;
generate a virtual account creation request based on the P2P payment account;
communicate the virtual account creation request to the payment system associated with the P2P payment account;
receive a virtual account identifier corresponding to the second user in response to the virtual account creation request; and
transfer the payment amount from the first user account associated with the first user to an account corresponding to the virtual account identifier.

10. The system of claim 9, wherein the at least one processor is further programmed or configured to:
receive an account identifier associated with the second user and the P2P payment account;
query the payment system to request data associated with the payment system corresponding to the P2P payment account based on the account identifier; and
receive the data associated with the payment system corresponding to the P2P payment account.

11. The system of claim 10, wherein, when determining the payment system, at least one processor is programmed or configured to:
determine the payment system corresponding to the P2P payment account based on the data associated with the payment system corresponding to the P2P payment account.

12. The system of claim 9, wherein the at least one processor is further programmed or configured to:
receive a response message from the payment system corresponding to the P2P payment account, the response message comprising an indication that the payment system determined to generate the virtual account identifier to receive the payment amount from the first user account.

13. The system of claim 9, wherein the at least one processor is further programmed or configured to:
receive an input from the first user via a graphical user interface of an application associated with the first payment processing network; and
generate a request based on the input received from the first user.

14. The system of claim 9, wherein the at least one processor is further programmed or configured to:
generate the virtual account identifier corresponding to the second user based on determining to generate the virtual account identifier to receive the payment amount from the first user account;
generate a response to the virtual account creation request, the response comprising the virtual account identifier corresponding to the second user; and
communicate the response to the first payment processing network.

15. The system of claim 9, wherein the virtual account identifier corresponds to at least one of a debit card and a prepaid payment card.

16. The system of claim 9, wherein the payment system comprises an issuer system corresponding to the P2P payment account.

17. A computer program product comprising at least one non-transitory computer readable medium comprising one or more instructions that, when executed by at least one processor, cause the at least one processor to:
receive a request from a first device operated by a first user to transfer a payment amount from a first user account corresponding to the first user and a first payment processing network to a second user having a peer-to-peer (P2P) payment account;
determine a payment system corresponding to the P2P payment account;
generate a virtual account creation request based on the P2P payment account;
communicate the virtual account creation request to the payment system associated with the P2P payment account;
receive a virtual account identifier corresponding to the second user in response to the virtual account creation request; and
transfer the payment amount from the first user account associated with the first user to an account corresponding to the virtual account identifier.

18. The computer program product of claim 17, wherein the one or more instructions further cause the at least one processor to:
receive an account identifier associated with the second user and the P2P payment account;
query the payment system to request data associated with the payment system corresponding to the P2P payment account based on the account identifier; and
receive the data associated with the payment system corresponding to the P2P payment account.

19. The computer program product of claim 18, wherein, when determining the second system, the one or more instructions cause the at least one processor to:
determine the second system corresponding to the P2P payment account based on the data associated with the payment system corresponding to the P2P payment account.

20. The computer program product of claim 17, wherein the one or more instructions further cause the at least one processor to:
receive a response message from the payment system corresponding to the P2P payment account, the response message comprising an indication that the payment system determined to generate the virtual account identifier to receive the payment amount from the first user account.

21-24. (canceled)
